(19) United States
(12) Patent Application Publication
(10) Pub. No.: US 2008/0226298 A1
(43) Pub. Date: Sep. 18, 2008

(54) Optical Transmission System

(75) Inventors: Hiroyuki Fukuyama, Tokyo (JP); Toshihiro Itoh, Tokyo (JP); Satoshi Tunashima, Tokyo (JP); Kimikazu Sano, Tokyo (JP); Koichi Murata, Tokyo (JP); Yohtaro Umeda, Tokyo (JP); Yasuo Tazoh, Tokyo (JP); Hirohiko Sugahara, Tokyo (JP); Hiromu Toba, Tokyo (JP); Masahiro Muraguchi, Tokyo (JP); Senichi Suzuki, Tokyo (JP); Seiji Fukushima, Tokyo (JP); Yoshinori Hibino, Tokyo (JP); Tadashi Sakamoto, Tokyo (JP); Yoshiaki Yamabayashi, Tokyo (JP); Eiji Yoshida, Tokyo (JP); Ryuichi Iwamoto, Tokyo (JP)

Correspondence Address: HOGAN & HARTSON L.L.P., 1999 AVENUE OF THE STARS, SUITE 1400, LOS ANGELES, CA, 90067, US

(73) Assignees: Nippon Telegraph and Telephone Corporation, Tokyo (JP); NTT Electronics Corporation, Tokyo (JP)

(21) Appl. No.: 10/598,089

(22) PCT Filed: Sep. 16, 2004
(86) PCT No.: PCT/JP2004/013515

§ 371 Date: Aug. 17, 2006

(30) Foreign Application Priority Data
Feb. 17, 2004 (JP) 2004-039130

(51) Int. Cl. H04B 10/13

(52) U.S. Cl. 398/143; 398/200

(57) ABSTRACT

The present invention has been achieved to provide a novel optical transmission system realizing high-speed optical transmission over greater distance by suppressing waveform degradation caused by mode dispersion and mode transition in a multimode optical transmission line. The optical transmission system of the present invention includes: an optical transmitter for transmitting incoherent light; an excitation mechanism for exciting a predetermined mode in the incoherent light transmitted from the optical transmitter; a multimode optical transmission line for transmitting the incoherent light transmitted from the excitation mechanism; a transmission mechanism for transmitting a predetermined mode in the incoherent light transmitted from the excitation mechanism; and an optical receiver for receiving the incoherent light transmitted from the transmission mechanism or the incoherent light transmitted from the transmission mechanism.

### CROSS-REFERENCE TO THE RELATED APPLICATIONS

This application is a national phase of PCT application No. PCT/JP2004/013515 filed on Sep. 16, 2004, the entire contents of which are incorporated by reference. This application also claims benefit of priority under 35 U.S.C. § 119 to Japanese Patent Application No. 2004-039130 filed on Feb. 17, 2004, the entire contents of which are incorporated by reference.

### TECHNICAL FIELD

The present invention relates to an optical transmission system including an optical transmitter, an optical receiver, and an optical transmission line connecting the optical transmitter and the optical receiver. More particularly, the invention relates to an optical transmission system realizing high-speed optical transmission over greater distance by suppressing waveform degradation caused by mode dispersion and mode transition in a multimode optical transmission line.

### BACKGROUND ART

Hitherto, a multimode optical fiber as an optical transmission line in which a plurality of modes can propagate is widely used for LANs (local area networks) in the same floor and among floors in a building and among buildings for the following reasons. A connection work is easy since the core diameter is large as about 50 μm or about 62.5 μm. Peripheral devices and parts of the multimode optical fiber are low in price.

As described above, in the conventional optical transmission system, as shown in FIG. 13, an optical transmitter 2 and an optical receiver 3 are connected to each other by using a multimode optical fiber 1 as an optical transmission line in which a plurality of modes can propagate.

In recent years, as the performance of computers is becoming higher and image data increases, higher speed of the optical transmission lines is. demanded. However, in the case of an optical transmission system having a conventional configuration as shown in FIG. 13, because of waveform degradation caused by variations in propagation delay among a plurality of modes (mode dispersion) propagating through the multimode optical fiber 1, the transmittable distance is limited to about 82 m at 10 Gbits/s and, even with a recent multimode optical fiber having a wide bandwidth (2000 MHz-km), about 300 m.

Consequently, in a building in which an old optical fiber has been laid, in the case of increasing the speed of a network from 100 Mbits/s or 1 Gbits/s to 10 Gbits/s, the transmission distance is not sufficient. In many cases, a single-mode optical fiber or a wide-band multimode optical fiber has to be newly laid. It causes a problem such that a large amount of cost is necessary.

On the other hand, as a method of avoiding the influence of mode dispersion in the case where a multimode optical fiber is used, an invention is disclosed such that the lowest-order mode is excited on the transmitter side by a structure that a single-mode optical fiber 4 is connected at the inlet part of the multimode optical fiber 1, for example, as shown in FIG. 14 (refer to, for example, patent document 1).

Another invention realizing transmission of a wider band by using light of short wavelength of 0.6 m to 1.0 m is disclosed (refer to, for example, patent document 2). According to the invention, in the case where a step index optical fiber having a core diameter of about 10 μm displaying a single-mode transmission characteristic at long wavelengths of 1.2 μm to 1.7 μm but displaying a multimode transmission characteristic at short wavelengths of 0.6 μm to 1.0 μm as mode regulations on the receiver side is used as an optical transmission line, a step index optical fiber having a core diameter of about 6 μm displaying the single mode transmission characteristic also at short wavelengths of 0.6 μm to 1.0 μm is connected at the outlet part.

Patent document 1: U.S. Pat. No. 6,185,346
Patent document 2: Japanese Patent Application Laid-Open No. 2003-21723

### DISCLOSURE OF INVENTION

### Problems to be Solved by the Invention

According to the invention described in the patent document 1, however, even when only the lowest-order mode is excited at the inlet part, occurrence of high-order modes cannot be avoided because an optical fiber is bent or stressed in some points in the optical transmission line. In the invention, high-order modes on the receiver side are not considered. Consequently, there is a drawback such that, due to the influence of mode dispersion caused by high-order modes generated during propagation, waveform degradation cannot be avoided.

In the invention described in the patent document 2, a single-mode optical fiber of a step index type having a core diameter of about 10 μm (multimode operations at short wavelengths) is assumed as the optical transmission line. The invention is expanded to a step index multimode optical fiber having a larger core diameter of, for example, 50 μm (multimode operations at both short and long wavelengths), the diameter of a base mode to be excited is as large as about 40 μm. The coupling loss with a single-mode optical fiber (as an optical fiber for excitation) having a mode diameter of about 10 μm becomes unignorably large as 6 dB or higher per connection point. There is a problem such that the invention is not practical.

On the other hand, the multimode optical fibers include not only the step index multimode optical fiber but also a graded-index multimode optical fiber.

In the graded-index multimode optical fiber, a refractive index distribution in the core has position dependence in order to suppress waveform degradation caused by variations in propagation delay among a plurality of modes propagating on the inside (mode dispersion).

However, in a conventional configuration of an optical transmission system standardized in “IEEE802.3 (revised in 2002) and IEEE802.3ae (2002)”, even when a graded-index multimode optical fiber in which mode dispersion is suppressed, is used, the propagation distance is strictly limited to the distance as long as that described above because mode dispersion degrades waveform.

Against such a backdrop, the applicants of the present invention have filed Japanese Patent Application No. 2003-296968. The application discloses a method of increasing transmission distance by avoiding the influence of mode dispersion in the case where a graded-index multimode optical fiber is used as an optical transmission line. In the method, an excitation mechanism is provided between an optical transmitter and the inlet of the optical transmission line or in some midpoint of the optical transmission line to excite only a specific mode (concretely, the base mode). At the same time, a transmission mechanism is provided in some midpoint of the optical transmission line or between the optical outlet of the optical transmission line and the optical receiver to transmit only the specific mode (concretely, the base mode).

FIG. 15 shows the configuration of an optical transmission system disclosed by the applicants of the present invention. Shown in the diagram are a graded-index multimode optical fiber 10, an optical transmitter 11 that emits coherent light, a coherent light source 12 which can be directly modulated, a single-mode optical fiber 13 for excitation, a single-mode optical fiber 14 for transmission, and an optical receiver 15.

In the optical transmission system disclosed by the applicants, mode components transferred from the specific mode within the optical transmission line are eliminated by the single-mode optical fiber 14 for a transmission mechanism. Consequently, waveform degradation caused by mode dispersion is suppressed and the propagation distance is increased. Since the single-mode optical fiber 13 for excitation excites only the mode that the single-mode optical fiber 14 for transmission passes, efficient optical transmission can be realized.

In the optical transmission system as disclosed in the invention by the applicants, however, generally, a coherent light source is used in the optical transmitter. There is consequently a drawback that mechanical disturbance may considerably degrade the waveform. FIG. 16 is a diagram illustrating the drawback.

The single-mode optical fiber 13, which is excitation mechanism shown in the diagram excites the mode A in a graded- index multimode optical fiber. At the point X, a part of light in the mode A is transferred to the mode B when there are local errors in the refractive index, microbending, or other scatterer. As described above, the light that keeps propagating in the mode B does not reach the optical receiver because the single-mode optical fiber 14 for transmission mechanism blocks the mode B.

However, when there are local errors in the refractive index, microbending, or other scatterer at the point Y between the point X and the transmission mechanism, a part of light in the mode B is transferred back to the mode A. At the point Y, the waveform is not determined by adding the waveform of light keeping the propagation mode in the mode A and that of the light which has been once transferred to the mode B and come back to the mode A. Since light has wave nature, the resultant waveform depends on the phase difference between the light keeping the propagation mode in the mode A and the light which has been once transferred to the mode B and come back to the mode A. If the phases are in-phase, constructive interference occurs. If the phases are anti-phase, destructive interference occurs.

In this case, if a coherent light source is used as the light source of the optical transmitter, the phases of propagating light are precisely identical, so that strong interference effect appears. Therefore, when the graded-index multimode optical fiber is subjected to mechanical disturbance, the phase difference between the light keeping the propagation mode in the mode A and the light which has been transferred to the mode B and come back to the mode A varies, and it causes severe degradation in the received waveform in the optical receiver.

In an actual graded-index multimode optical fiber, inter-mode transition occurs not only at the points X and Y but occurs in the whole optical fiber. Furthermore, the number of the mode which can be transferred to is not only one, since a large number of modes contributes to the propagation, so a very complicated interference effect appears.

The present invention has been achieved in view of such circumstances and an object of the invention is to provide a novel optical transmission system realizing high-speed optical transmission over greater distance by suppressing waveform degradation caused by mode dispersion and mode transition in a multimode optical transmission line.

### Means for Solving the Problem

To achieve the object, an optical transmission system of the present invention includes: an optical transmitter for transmitting incoherent light; an excitation mechanism for exciting a predetermined mode in the incoherent light transmitted from the optical transmitter or the incoherent light transmitted from the optical transmitter via a multimode optical transmission line; and a transmission mechanism for transmitting a predetermined mode in the incoherent light transmitted from the excitation mechanism via a multimode optical transmission line.

Another optical transmission system of the present invention includes: an optical transmitter for transmitting incoherent light; an excitation mechanism for exciting a predetermined mode in the incoherent light transmitted from the optical transmitter or the incoherent light transmitted from the optical transmitter via a multimode optical transmission line; a transmission mechanism for transmitting a predetermined mode in the incoherent light transmitted from the excitation mechanism via a multimode optical transmission line; and an optical receiver for receiving the incoherent light transmitted from the transmission mechanism or the incoherent light transmitted from the transmission mechanism via a multimode optical transmission line.

Another optical transmission system of the present invention includes: an optical transmitter for transmitting incoherent light; an excitation mechanism for exciting a predetermined mode in the incoherent light transmitted from the optical transmitter or the incoherent light transmitted from the optical transmitter via a multimode optical transmission line; a multimode optical transmission line for transmitting the incoherent light transmitted from the excitation mechanism; and a transmission mechanism for transmitting a predetermined mode in the incoherent light transmitted from the excitation mechanism via the multimode optical transmission line.

Further another optical transmission system of the present invention includes: an optical transmitter for transmitting incoherent light; an excitation mechanism for exciting a predetermined mode in the incoherent light transmitted from the optical transmitter or the incoherent light transmitted from the optical transmitter via a multimode optical transmission line; a multimode optical transmission line for transmitting the incoherent light transmitted from the excitation mechanism; a transmission mechanism for transmitting a predetermined mode in the incoherent light transmitted from the excitation mechanism via the multimode optical transmission line; and an optical receiver for receiving the incoherent light transmitted from the transmission mechanism or the incoherent light transmitted from the transmission mechanism via a multimode optical transmission line.

With the configuration, desirably, the optical transmitter has an incoherent light source and a optical modulator for modulating light emitted from the incoherent light source and outputting the modulated light as the incoherent light.

Preferably, the optical transmitter has an incoherent light source which can be directly modulated and emits the incoherent light.

Preferably, the incoherent light source is an ASE light source.

Preferably, a graded-index optical transmission line or a step index optical transmission line is used as the multimode optical transmission line.

When the multimode optical transmission line is a graded-index optical transmission line, desirably, the graded-index optical transmission line takes the form of a graded-index multimode optical fiber having a core diameter of 40 μm or more and 100 μm or less.

When the multimode optical transmission line is a graded-index optical transmission line, desirably, the graded-index optical transmission line takes the form of a graded-index multimode optical fiber having a core diameter of 50 μm or 62.5 μm.

In the case where the multimode optical transmission line is a step index optical transmission line, desirably, the step index optical transmission line takes the form of a step index multimode optical fiber having a core diameter of 40 μm or more and 100 μm or less.

In the case where the multimode optical transmission line is a step index optical transmission line, desirably, the step index optical transmission line takes the form of a step index multimode optical fiber having a core diameter of 50 μm or 62.5

The predetermined mode is desirably a base mode.

It is desirable to use a single-mode optical transmission line as the excitation mechanism.

In this case, it is desirable to use a single-mode optical fiber or a single-mode planar lightwave circuit as the single-mode optical transmission line.

Preferably, the excitation mechanism includes a lens that transmits the incoherent light transmitted from the optical transmitter, a predetermined low-order mode in the incoherent light transmitted from the optical transmitter is condensed by the lens, and the resultant light is transmitted.

Preferably, the excitation mechanism includes a diaphragm having an aperture that passes the incoherent light transmitted from the optical transmitter, a predetermined low-order mode in the incoherent light transmitted from the optical transmitter is selected by the diaphragm, and the resultant light is transmitted.

In this case, desirably, the diaphragm includes a first diaphragm for passing the incoherent light transmitted from the optical transmitter and a second diaphragm for passing the incoherent light passed through the first diaphragm.

As described above, as the excitation mechanism, a single-mode optical transmission line taking the form of a single-mode optical fiber or a single-mode planar lightwave circuit, an optical system including a lens, or a diaphragm having an aperture in a specific position in an optical transmission core can be used.

Preferably, a single-mode optical transmission line is used as the transmission mechanism.

In this case, it is desirable to use a single-mode optical fiber or a single-mode planar lightwave circuit as the single-mode optical transmission line.

Preferably, the transmission mechanism includes a lens that transmits the incoherent light transmitted from the excitation mechanism, a predetermined low-order mode in the incoherent light transmitted from the excitation mechanism is condensed by the lens, and the resultant light is transmitted.

Preferably, the transmission mechanism includes a diaphragm having an aperture that passes the incoherent light transmitted from the excitation mechanism, a predetermined low-order mode in the incoherent light transmitted from the excitation mechanism is selected by the diaphragm, and the resultant light is transmitted.

In this case, desirably, the diaphragm includes a first diaphragm for passing the incoherent light transmitted from the excitation mechanism and a second diaphragm for passing the incoherent light passed through the first diaphragm.

As described above, as the transmission mechanism, a single-mode optical transmission line taking the form of a single-mode optical fiber or a single-mode planar lightwave circuit, an optical system including a lens, or a diaphragm having an aperture in a specific position in an optical transmission core can be used.

### EFFECTS OF THE INVENTION

The high-speed optical transmission system of the present invention can be realized by suppressing waveform degradation caused by mode dispersion in a multimode optical transmission line, so that it achieves greater transmission distance than conventional optical transmission systems. Furthermore, by removing the interference effect accompanying inter-mode transition, degradation in the received waveform caused by mechanical disturbance can be suppressed. By applying the present invention to a laid local area network consisting of graded-index multimode optical fibers and step index multimode optical fibers, the date rate of the laid local area network can be increased. Thus, a high speed local area network can be realized at low cost.

### BRIEF DESCRIPTION OF THE DRAWINGS

FIG. 1 is a diagram showing an example of a system configuration of a first embodiment.

FIG. 2 is a diagram showing an example of a system configuration of a second embodiment.

FIG. 3 is a diagram illustrating the present invention.

FIG. 4 is a diagram illustrating effects of the present invention.

FIG. 5 is a diagram showing an example of a system configuration of a third embodiment.

FIG. 6 is a diagram showing another example of the system configuration of the third embodiment.

FIG. 7 is a diagram showing an example of a system configuration of a fourth embodiment.

FIG. 8 is a diagram showing another example of the system configuration of the fourth embodiment.

FIG. 9 is a diagram showing an example of a system configuration of a fifth embodiment.

FIG. 10 is a diagram showing an example of a system configuration of a sixth embodiment.

FIG. 11 is a diagram showing an example of a system configuration of a seventh embodiment.

FIG. 12 is a diagram showing an example of another embodiment of a diaphragm of the seventh embodiment.

FIG. 13 is a diagram showing a system configuration of a conventional technique.

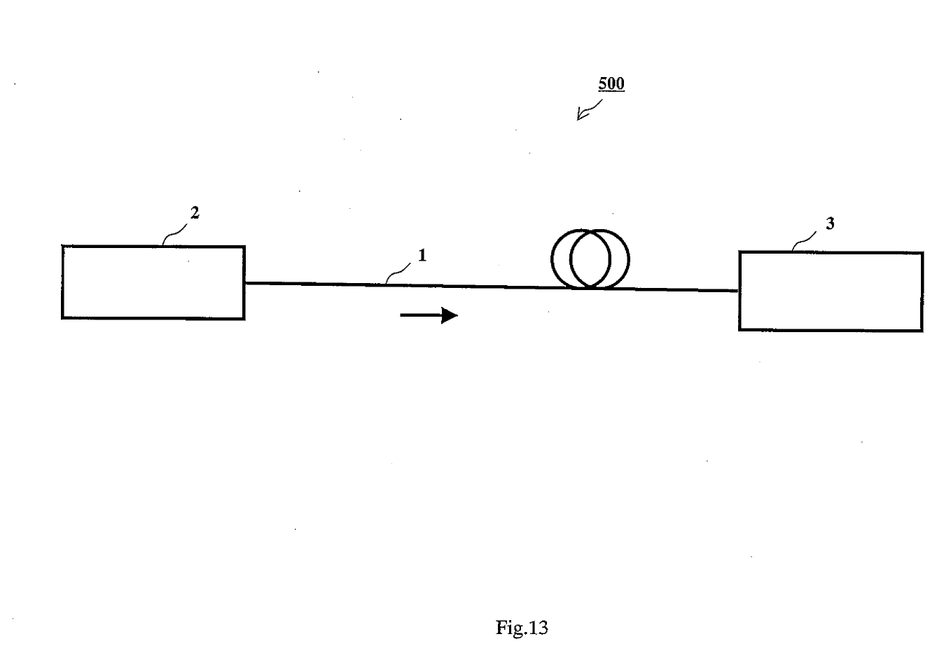

FIG. 14 is a diagram showing a system configuration of a conventional technique.

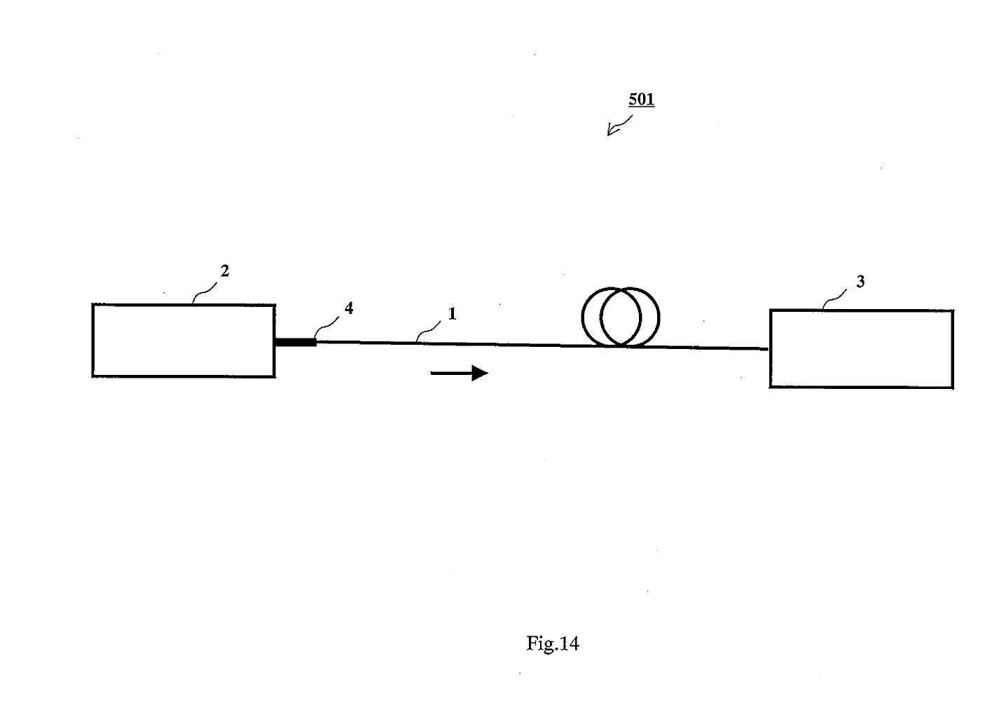

FIG. 15 is a diagram illustrating the configuration of an optical transmission system disclosed by the applicants of the present invention.

FIG. 16 is a diagram illustrating a drawback of the optical transmission system disclosed by the applicants of the present invention.

### DESCRIPTION OF THE REFERENCE NUMERALS

Reference numerals in the drawings are described as follows. 1: multimode optical fiber, 2: optical transmitter, 3: optical receiver, 4: single-mode optical fiber, 10: graded-index multimode optical fiber, 11: optical transmitter for emitting coherent light, 12: coherent light source which can be directly modulated, 13: single-mode optical fiber for excitation, 14: single-mode optical fiber for transmission, 15: optical receiver, 16, 17, 18: multimode optical transmission lines, 20: optical transmitter for emitting incoherent light, 21: exciting mechanism, 22: transmission mechanism, 100 to 106: optical transmission systems according to the embodiments of the invention, 500 to 502: conventional optical transmission systems, 201: incoherent light source, 202: optical modulator, 203: wavelength filter mechanism, 204: polarization control mechanism, 205: incoherent light source which can be directly modulated, 30: single-mode planar light wave circuit for excitation, 31: single-mode planar light wave circuit for transmission, 40: graded-index multimode optical fiber for connection, 41: graded-index multimode optical fiber for connection, 50: optical system for excitation, 51: optical system for transmission, 60: graded-index multimode optical fiber for connection, 61: graded-index multimode optical fiber for connection, 70: diaphragm for excitation, 71: diaphragm for transmission, 80: graded-index multimode optical fiber for connection, 81: graded-index multimode optical fiber for connection, 82: transmission data

### BEST MODE FOR CARRYING OUT THE INVENTION

Embodiments of the present invention will be described in detail hereinbelow. The invention is not limited to the following description.

### First Embodiment

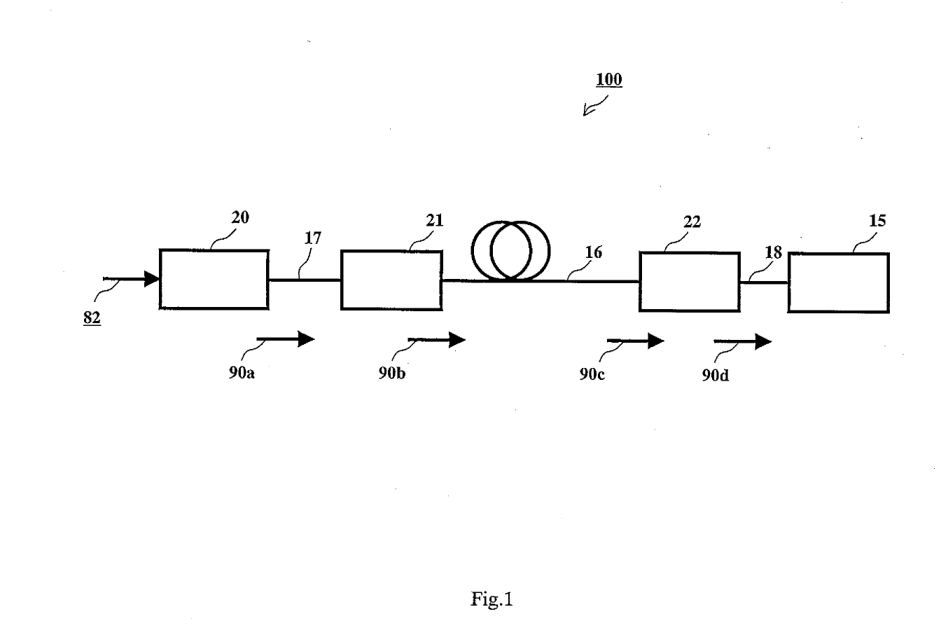

FIG. 1 shows an example of a first embodiment of an optical transmission system according to the present invention.

Shown in the diagram are multimode optical transmission lines 16, 17, and 18, an optical transmitter 20 that emits incoherent light, an excitation mechanism 21, a transmission mechanism 22, and an optical receiver 15.

An optical transmission system 100 shown in FIG. 1 has the optical transmitter 20 for transmitting incoherent light 90a, the excitation mechanism 21 for exciting a predetermined mode in the incoherent light 90a transmitted from the optical transmitter 20 via the multimode optical transmission line 17 and transmitting incoherent light 90b toward the optical receiver 15, the multimode optical transmission line 16 for transmitting incoherent light 90c transmitted from the excitation mechanism 21, the transmission mechanism 22 passing a predetermined mode in the incoherent light 90c transmitted from the excitation mechanism 21 via the multimode optical transmission line 16, and the optical receiver 15 for receiving the incoherent light 90d transmitted from the transmission mechanism 22 via the multimode optical transmission line 18.

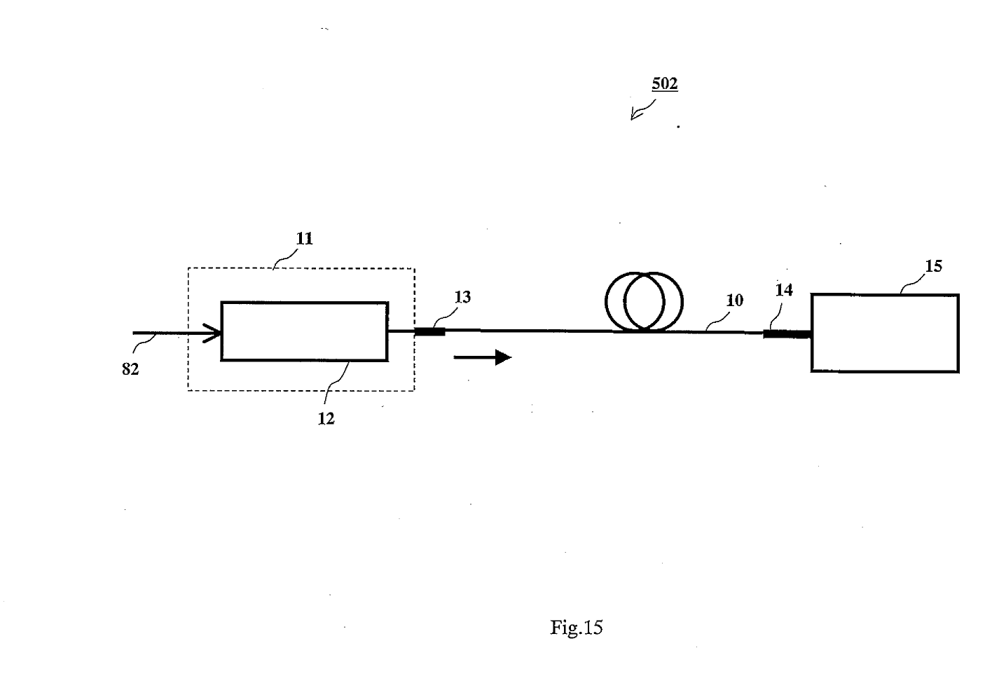

As described above, when the optical transmission system 100 according to the first embodiment employs the configuration of the optical transmission system shown in FIG. 15 disclosed by the applicants of the present invention, the optical transmitter 20 for emitting incoherent light is used as a basic component. Though, in the first embodiment, the optical transmitter 20 and the excitation mechanism 21 are connected to each other via the multimode optical transmission line 17, and the transmission mechanism 22 and the optical receiver 15 are connected to each other via the multimode optical transmission line 18, the excitation mechanism 21 may directly excite the incoherent light 90a transmitted from the optical transmitter 20. In this case, transmission degradation caused by mode dispersion in the multimode optical transmission line 17 can be prevented. The optical receiver 15 may directly receive the incoherent light 90d emitted from the transmission mechanism 22. In this case, transmission degradation caused by mode dispersion in the multimode optical transmission line 18 can be prevented.

In the optical transmission system 100 according to the first embodiment, the optical transmitter 20 transmits the incoherent light 90a. Since the incoherent light has less incoherence, interference itself caused by variations in propagation delay of light finally received by the optical receiver 15 can be suppressed. Therefore, degradation in a waveform received by the optical receiver 15 can be suppressed. Preferably, the optical transmitter 20 has an incoherent light source as a light source of the incoherent light 90a. Further, the incoherent light source is desirably, an ASE (Amplified Spontaneous Emission) light source. The ASE light source is a light source that emits high-intensity, wideband incoherent light. By having the ASE light source, the optical transmitter 20 can perform wideband optical transmission.

In the optical transmission system 100 according to the first embodiment, the excitation mechanism 21 excites a predetermined mode in the incoherent light 90a transmitted from the optical transmitter 20 and transmits the resultant light. The excitation implies here selection of a mode that passes the system. That is, the excitation mechanism 21 selects a predetermined mode in the incoherent light 90a transmitted from the optical transmitter 20 and transmits it. By selecting and transmitting a predetermined mode, the mode of light propagating in the optical transmission line can be preliminarily limited to a predetermined low-order mode. Consequently, mainly, high-order modes in light which is mode-dispersed by mechanical disturbance or the like in the multimode optical transmission line 17 in the incoherent light 90a can be eliminated. Since the incoherent light 90b transmitted to the multimode optical transmission line 16 can be limited mainly to low-order modes, mode dispersion of the incoherent light 90b in the multimode optical transmission line 16 can be suppressed.

The predetermined mode excited by the excitation mechanism 21 is desirably, a low-order mode and more desirably, a base mode. The base mode is the lowest-order mode. By using the base mode as the predetermined mode, a mode propagating around the center of an optical fiber can be excited, so that the mode dispersion is small and a wideband frequency characteristic is obtained. In the following description, obviously, the “low-order mode” includes the “base mode”.

In this case, in the optical transmission system 100, it is desirable to apply a single-mode optical fiber for excitation as the excitation mechanism 21. The single-mode optical fiber is an optical fiber in which only one mode of light propagates. By applying the single-mode optical fiber for excitation as the excitation mechanism 21, the angle of incidence to the excitation mechanism 21 of the incoherent light 90a transmitted from the optical transmitter 20 can be easily limited, and the base mode can be excited.

In the optical transmission system 100 according to the embodiment, the transmission mechanism 22 passes and transmits a predetermined mode in the incoherent light 90b transmitted from the excitation mechanism. Bypassing and transmitting the predetermined mode, the incoherent light which is mode-dispersed by mechanical disturbance of the multimode optical transmission line 16 can be limited only to low-order modes, and the resultant can be transmitted to the optical transmitter 15. Therefore, degradation in received waveforms in the optical receiver 15 can be prevented.

The predetermined mode passing through the transmission mechanism 22 is desirably, a low-order mode and, more desirably, the base mode. The base mode is the lowest-order mode. By using the base mode as the predetermined mode, a mode propagating around the center of an optical fiber is passed, so that the mode dispersion is small and a wideband frequency characteristic is obtained.

In this case, in the optical transmission system 100 according to the first embodiment, it is desirable to apply a single-mode optical fiber for transmission as the transmission mechanism 22. Since the angle of incidence to the transmission mechanism 22 of the incoherent light 90c transmitted by the excitation mechanism 21 can be limited, the single-mode optical fiber for transmission can easily transmit the base mode.

In the optical transmission system 100 according to the embodiment, a step index multimode optical fiber can be applied as the multimode optical transmission line 16. In the step index multimode optical fiber, the refractive index in the center of the core is higher than that of the cladding and uniform, and the refractive index in the center of the core and that of the cladding are discontinuously various. Light propagating through a step index multimode optical fiber travels while being totally reflected by the border between the core and the cladding. Consequently, in the step index multimode optical fiber, when local errors in the index of refraction of the optical fiber or mechanical disturbance such as microbending occurs, the orbit of light or reflection angle changes on occurrence of mechanical disturbance. Due to the change, the light even in the low-order mode may be transferred to a high-order mode depending on a change in the orbit or the reflection angle. Since such mechanical disturbance of the optical fiber occurs in the entire optical fiber, the mode of light propagating through the optical fiber is transferred complicatedly. As a result, interference occurs due to variations in propagation delay of light, and the waveform degrades.

In the optical transmission system 100 of the first embodiment, however, the incoherent light propagating through the step index multimode optical fiber as the multimode optical transmission line 16 can be limited to a low-order mode in advance by the excitation mechanism 21. The transmission mechanism 22 transmits the selected low-order mode in the incoherent light in which the mode transition occurs during the propagation in the step index multimode optical fiber as the multimode optical transmission line 16, so that mode dispersion can be suppressed. Further, in the optical transmission system 100, the incoherent light is used as light transmitted/received between the optical transmitter 20 and the optical receiver 15, so that interference itself among the modes can be suppressed. Therefore, in the optical transmission system 100, mode dispersion of light in the step index multimode optical fiber as the multimode optical transmission line 16 and degradation of waveform due to interference among the modes can be suppressed, and transmission quality can be improved.

The core diameter of the step index multimode optical fiber is desirably in a range from 40 μm or more and 100 μm or less. By setting the core diameter of the step index multimode optical fiber to be relatively large as 40>m or more and 100 μm or less, the connection work can be facilitated. More desirably, the core diameter is 50 μm or 62.5 μm. Since an optical fiber having the core diameter of 50 μm and that having the core diameter of 62.5 μm exist as standard products, low-price peripheral devices and parts to be connected with the optical fiber can be used.

In the optical transmission system 100 of the first embodiment, a graded-index multimode optical fiber can be used instead of a step index multimode optical fiber as the multimode optical transmission line 16. The graded-index multimode optical fiber is an optical fiber in which the refractive index in the center of the core is the maximum and decreases toward the outside.

The orbit of light that entered the core is bent in peripheral portions of the core, where the refractive index is low, so that it becomes a curve that meanders around the core center as an axis. Since the refractive index in the center of the core is relatively higher than that in the peripheral parts of the core, the velocity of light propagating in the center of the core is lower than that of light in the core peripheral parts. Consequently, propagation velocity can be made constant independent of the modes of light.

However, since the refractive index in the graded-index multimode optical fiber has to be varied gradually, it is difficult to manufacture the graded-index multimode optical fiber with ideal dispersion of the refractive index. In this case, local errors of the refractive index of the optical fiber disperse the propagation velocities of the light propagating through the graded-index multimode optical fiber relatively among the modes as the transmission distance increases. Consequently, even in the graded-index multimode optical fiber, as the transmission distance increases, variations in the propagation delay occur in the light propagating through the optical fiber.

On the other hand, in the optical transmission system 100 of the first embodiment, however, the incoherent light propagating through the graded-index multimode optical fiber as the multimode optical transmission line 16 can be limited to a low-order mode in advance by the excitation mechanism 21. The transmission mechanism 22 transmits mainly the selected low-order mode in the incoherent light which is mode-dispersed in the graded-index multimode optical fiber as the multimode optical transmission line 16, so that mode dispersion caused by variations in the propagation delay among the modes can be suppressed. Further, in the optical transmission system 100, the incoherent light is used as light transmitted/received between the optical transmitter 20 and the optical receiver 15, so that interference itself among the modes can be suppressed. Therefore, in the optical transmission system 100, mode dispersion of light in the graded-index multimode optical fiber as the multimode optical transmission line 16 and degradation of waveform due to interference among the modes can be suppressed, and transmission quality can be further improved.

The core diameter of the graded-index multimode optical fiber is desirably in a range 40 μm or more and 100 μm or less. By setting the core diameter of the graded-index multimode optical fiber to be relatively large as 40 μm or more and 100 μm or less, the connection work can be facilitated. More desirably, the core diameter is 50 μm or 62.5 μm. Since an optical fiber having the core diameter of 50 μm and that having the core diameter of 62.5 μm exist as standard products, low-price peripheral devices and parts to be connected with the optical fiber can be used.

Any optical transmission line as long as it can transmit light having a plurality of modes can be applied to the optical transmission system 100 according to the embodiment. In the optical transmission system 100, as described above, transmission degradation caused by mode dispersion which occurs in the optical transmission line and interference among the modes can be suppressed.

In the first embodiment, the optical receiver 15 is provided. By providing the optical receiver 15, an optical transmission system with extremely suppressed transmission degradation can be configured. The embodiment also includes the case where the optical receiver 15 is not provided. In this case, the optical transmission system of the embodiment not having the optical receiver 15 can be assembled in an existing optical transmission system having an optical receiver, so that the existing optical transmission system with extremely reduced transmission degradation can be achieved.

The operation of the optical transmission system 100 will be described with reference to FIG. 1.

First, the optical transmitter 20 transmits the incoherent light 90a, which is an optical signal converted from transmission data 82 input to the optical transmitter 20, toward the optical receiver 15. The incoherent light 90a transmitted from the optical transmitter 20 propagates through the excitation mechanism 21 and enters, as the incoherent light 90b, the multimode optical transmission line 16. Since the incoherent light 90a is limited mainly to the low-order mode by the excitation mechanism 21 and transmitted, mode dispersion of the incoherent light 90b propagating through the multimode optical transmission line 16 can be suppressed.

The incoherent light 90c propagated through the multimode optical transmission line 16 passes through the transmission mechanism 22 and is transmitted as the incoherent light 90d toward the optical receiver 15. Since the incoherent light 90c is limited mainly to the low-order mode by the transmission mechanism 22 and is transmitted toward the optical receiver 15, mode dispersion of the incoherent light 90d can be suppressed and degradation of the received waveform of the optical receiver 15 can be suppressed. Further, the incoherent light is used as light transmitted/received between the optical transmitter 20 and the optical receiver 15, so that interference itself among the modes can be suppressed. Therefore, degradation of received waveform in the optical receiver 15 can be prevented.

As described above, in the optical transmission system 100 according to the first embodiment, by suppressing waveform degradation caused by interference among the modes accompanying mode dispersion and inter-mode transition of the multimode optical transmission line, high-speed light transmission over greater distance that a conventional distance can be realized.

### Second Embodiment

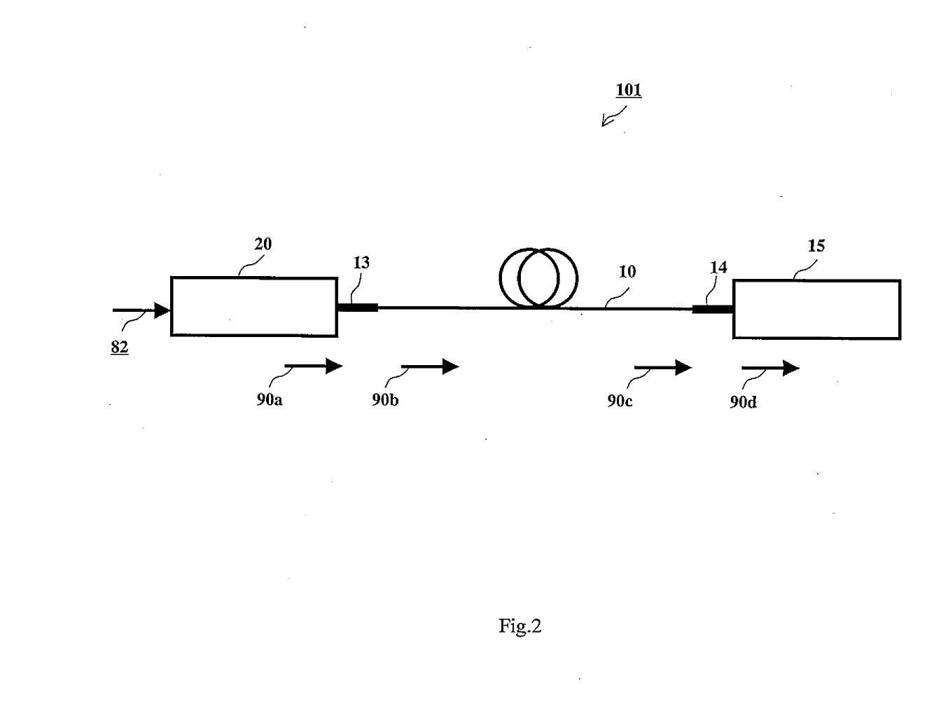

FIG. 2 shows a second embodiment of the optical transmission system according to the present invention. In the second embodiment, the optical transmission system obtained by further embodying the optical transmission system of the first embodiment will be described.

Shown in the diagram are a graded-index multimode optical fiber 10 as a multimode optical transmission line, the optical transmitter 20 that emits incoherent light, a single mode optical fiber 13 for excitation as an excitation mechanism, a single mode optical fiber 14 for transmission as a transmission mechanism, and the optical receiver 15.

When an optical transmission system 101 according to the second embodiment employs the configuration of the optical transmission system shown in FIG. 15 disclosed by the applicants of the present invention, the optical transmitter 20 for emitting incoherent light is used as a basic component. The configuration of the optical transmitter 20 is similar to that of the first embodiment.

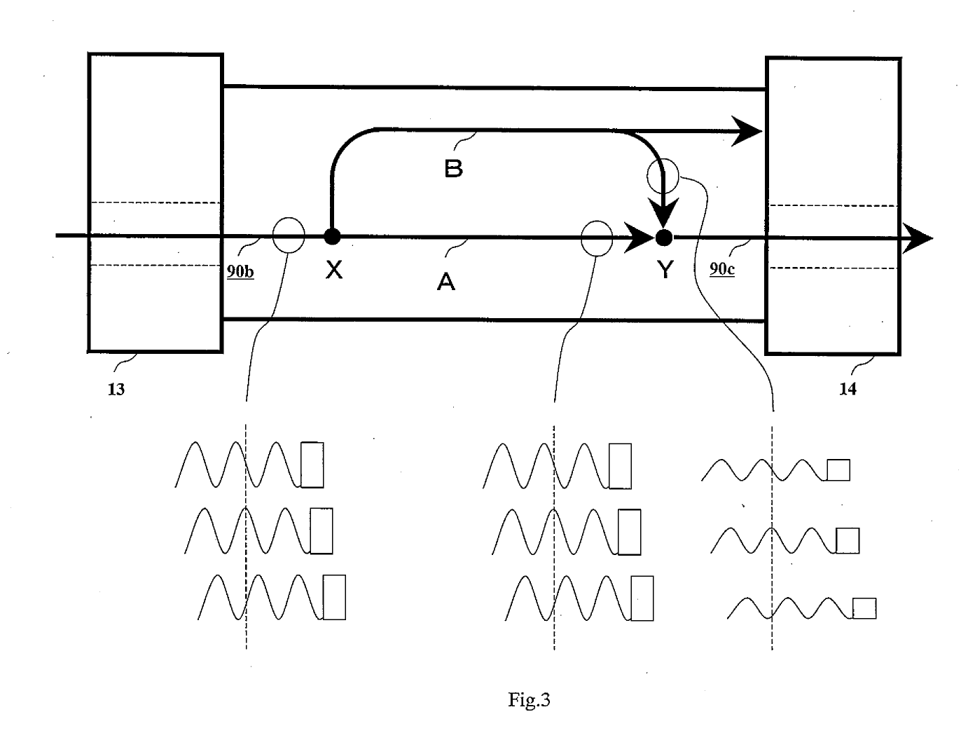

FIG. 3 is a schematic diagram showing an example of inter-mode transition of incoherent light propagating through the multimode optical transmission line illustrated in FIG. 2. As shown in FIG. 3, a part of the incoherent light 90b transmitted from the single mode optical fiber 13 for excitation as an excitation mechanism is transferred from the mode A to the mode B, for example, due to microbending in the optical fiber at the point X. A part of the transferred light propagating in the mode B is transferred again to the mode A, for example, due to microbending in the optical fiber at the point Y. Another part which is not transferred to the mode B at the point X propagates in the mode A toward the single-mode optical fiber 14 for transmission as a transmission mechanism. The light having in the propagation mode A and the light which has been transferred to the mode B and again transferred back to the mode A interfere in each other at the point Y. In FIG. 3, the phase configuration of light signals before the X and Y points is schematically shown by using sine waves.

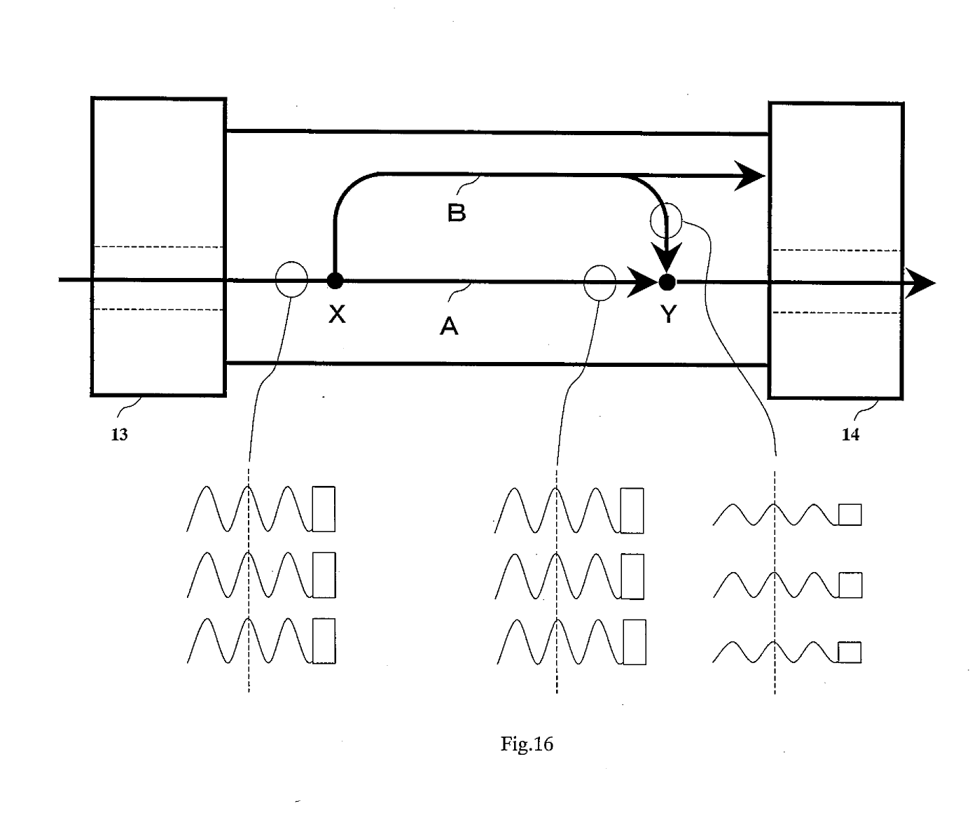

Since the optical transmission system 101 according to the second embodiment shown in FIG. 2 uses an incoherent light source as the light source of the light transmitter 20, the propagating light has random phase as shown in FIG. 3 unlike the case of using a coherent light source, and coherence is low. Consequently, as shown in FIG. 3, the interference effect is weak, which is produced by the light keeping in the propagation mode A and the light which has been transferred to the mode B and transferred again to the mode A shown in FIG. 16. Therefore, even if inter-mode transition occurs due to local errors in the refractive index, microbending, or the like, inside a graded-index multimode optical fiber 10, the received waveform is not degraded by mechanical disturbance.

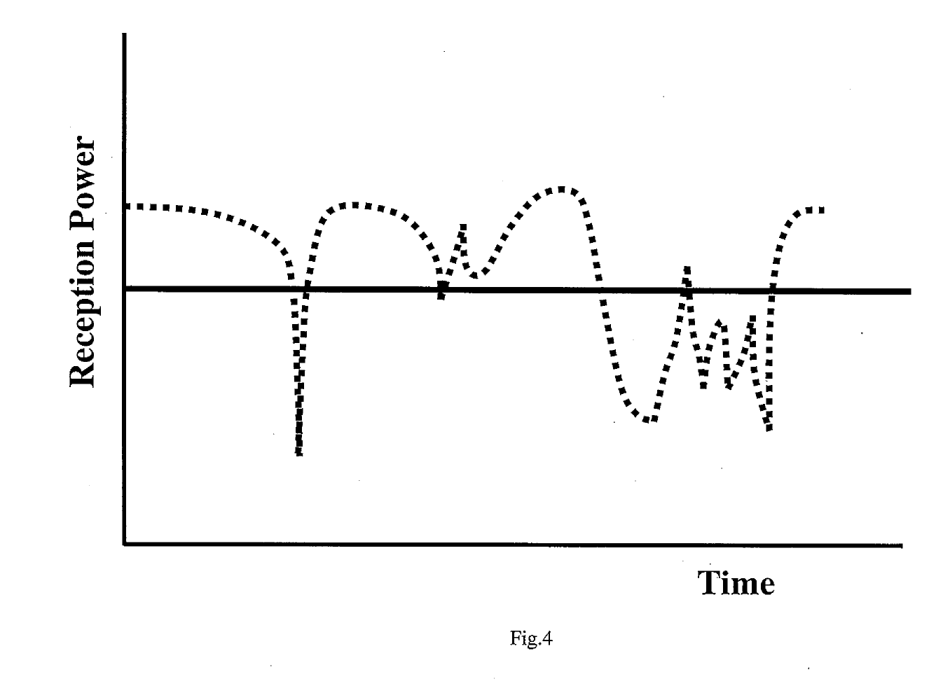

FIG. 4 shows fluctuations with time in received power in the optical receiver 15 in the optical transmission system 101 illustrated in FIG. 2. In FIG. 4, the solid line indicates fluctuations with time in received power in the case of using the incoherent light, and the dot line shows fluctuations with time in received power in the case of using the coherent light.

As shown in the graph, since the conventional optical transmission system generally uses the coherent light source, fluctuation with time occurs in the received power due to temperature change or mechanical disturbance such as vibration. In contrast, the optical transmission system 101 shown in FIG. 2 uses the incoherent light source for the optical transmitter 20. Consequently, the optical transmission system 101 is less affected by such mechanical disturbance, and fluctuation with time in the received power hardly occurs.

The operation of the optical transmission system 101 is similar to that of the first embodiment.

### Third Embodiment

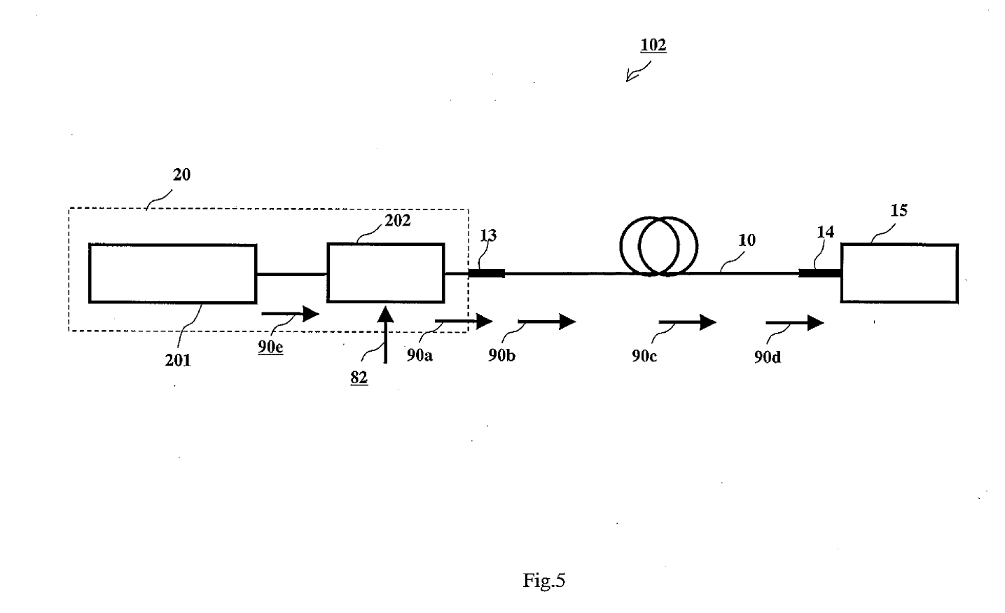

FIG. 5 shows a third embodiment of the optical transmission system according to the present invention. The same reference numerals are designated to the same components as those in FIG. 2.

In the third embodiment, the optical transmitter 20 is constructed by an incoherent light source 201 and a optical modulator 202. The optical modulator 202 modulates light transmitted from the incoherent light source 201 on the basis of the transmission data 82 input to the optical modulator 202, and transmits the resultant light as the incoherent light 90a. For the modulation, a modulating method such as intensity modulation or wavelength modulation can be applied.

As the incoherent light source 201, an ASE light source for taking spontaneous emission light of a fiber amplifier, a super luminescent diode (SLD), a light emission diode (LED), or the like can be used. As the optical modulator 202, an LN modulator using a known LiNbO₃ crystal, an electroabsorption (EA) modulator, or the like can be used.

In an optical transmission system 102 of the third embodiment, by providing the optical transmitter 20 with the incoherent light source 201 and the optical modulator 202, the optical transmitter 20 has the function of an information transmitter.

The operation of the optical transmitter 20 of the optical transmission system 102 according to the third embodiment will be described. The operations of the optical transmission system 102 after the incoherent light 90a is transmitted from the optical transmitter 20 until the incoherent light 90a is received by the optical receiver 15 are similar to those in the first embodiment.

First, the incoherent light 90e is transmitted from the incoherent light source 201 to the optical modulator 202. When the transmission data 82 is input, the optical modulator 202 performs, for example, intensity modulation on the incoherent light 90e on the basis of the input transmission data 82 and transmits the resultant light as the incoherent light 90a.

As described above, the third embodiment is obtained by embodying the configuration of the optical transmitter 20 in the second embodiment. For reasons similar to those of the second embodiment, degradation in the received waveform due to mechanical disturbance does not occur.

The configuration of the optical transmitter 20 having the incoherent light source 201 and the optical modulator 202 as shown in FIG. 5 can be applied to any of the embodiments described in the specification.

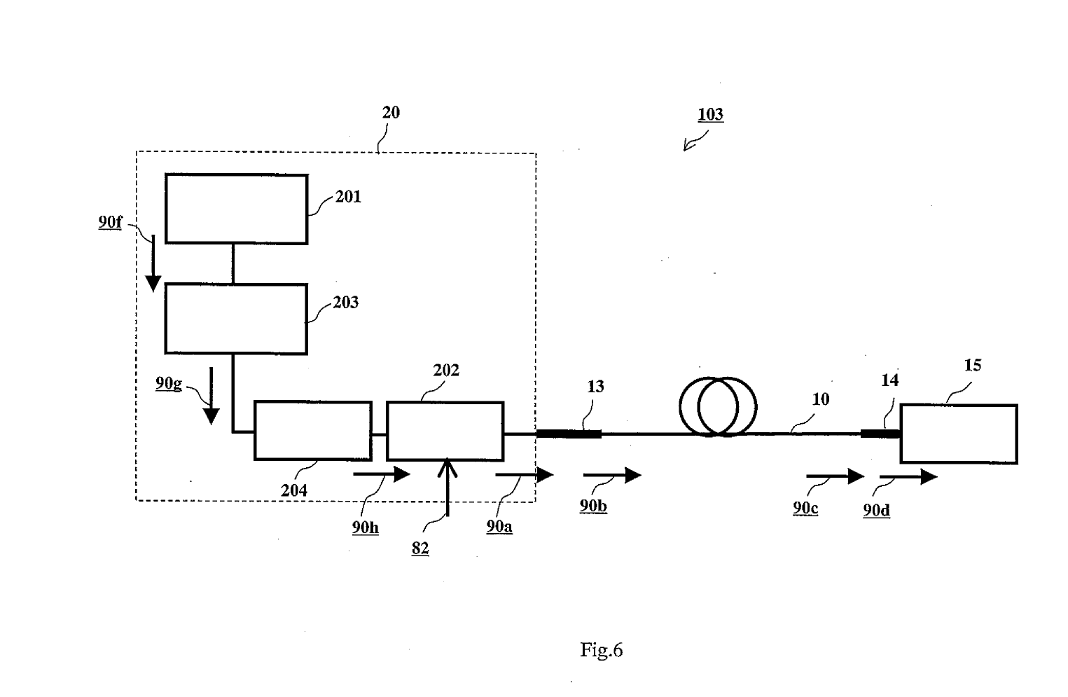

FIG. 6 shows another example of the third embodiment of the optical transmission system according to the invention. The same reference numerals are designated to the same components as those in FIG. 5.

In the configuration example, the optical transmitter 20; is constructed by the incoherent light source 201, a wavelength filter mechanism 203, a polarization control mechanism 204, and the optical modulator 202.

The wavelength filter mechanism 203 is inserted to suppress waveform degradation caused by wave bandwidth of the optical modulator 202 and wavelength dispersion in the graded-index multimode optical fiber 10. The polarization control mechanism 204 is inserted to optimize the modulation effect in consideration of polarization dependency of the optical modulator 202.

Therefore, in the case of using a polarization-independent optical modulator as the optical modulator 202, the polarization control mechanism 204 is unnecessary. The wavelength filter mechanism 203 may be inserted between the optical modulator 202 and the single-mode optical fiber 13 for excitation.

As the wavelength filter mechanism 203, for example, an optical waveguide wavelength filter or a WDM (wavelength division multiplexing) tunable wavelength filter can be applied. By applying any of the wavelength filter mechanisms, a flexible system without a change in the optical transmission system according to the wavelength of incoherent light to be transmitted can be realized.

The polarization control mechanism 204 adjusts the polarization direction of a light signal 90g transmitted from the incoherent light source 201. For example, only light in a predetermined polarization direction is taken from the light signal 90g by using a polarization beam splitter or a deflection plate, or the polarization direction of the light signal 90g is aligned to a predetermined direction.

The operation of the optical transmitter 20 of the optical transmission system 103 of the third embodiment will now be described. The operations of the optical transmission system 103 after the incoherent light 90a is transmitted from the optical transmitter 20 until the incoherent light 90a is received by the optical receiver 15 are similar to those in the first embodiment.

First, the incoherent light source 201 transmits incoherent light 90f toward the optical modulator 202. The incoherent light 90f is received by the wavelength filter mechanism 203. The wavelength filter mechanism 203 limits the wavelength range of the incoherent light 90f and transmits the resultant light as the incoherent light 90g. The incoherent light 90g is received by the polarization control mechanism 204. The polarization control mechanism 204 controls the polarization direction of the incoherent light 90g and transmits the resultant light as incoherent light 90h. The incoherent light 90h is received by the optical modulator 202. When the transmission data 82 is input, the optical modulator 202 performs, for example, intensity modulation on the incoherent light 90h on the basis of the input transmission data 82 and transmits the resultant as the incoherent light 90a.

As described above, in the third embodiment, the configuration of the optical transmitter 20 of the second embodiment is embodied. For reasons similar to those of the second embodiment, degradation in received waveform due to mechanical disturbance does not occur.

### Fourth Embodiment

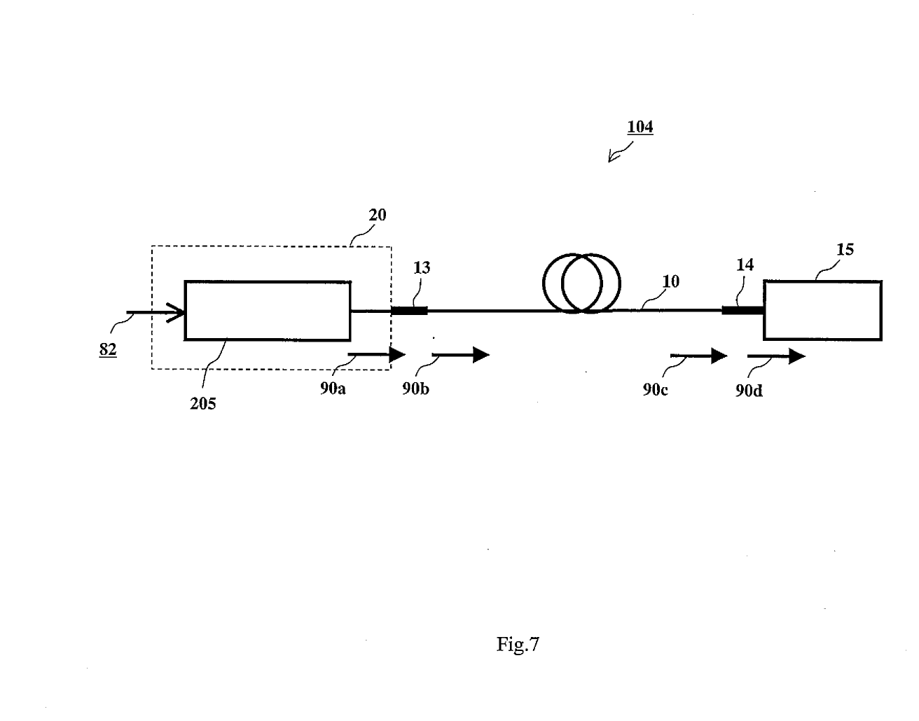

FIG. 7 shows a fourth embodiment of the optical transmission system according to the present invention. The same reference numerals are designated to the same components as those in FIG. 2.

In the fourth embodiment, the optical transmitter 20 is constructed by an incoherent light source 205 which can be directly modulated. The direct modulation is, for example, direct modulation of brightness of a laser diode by inputting a modulation signal to a drive current of the laser diode.

In the fourth embodiment, by providing the optical transmitter 20 with the incoherent light source 205 which can be directly modulated, it is unnecessary to provide an external modulator. Thus, the optical transmitter 20 can be made compact.

The incoherent light source 205 which can be directly modulated is, desirably, an ASE (Amplified Spontaneous Emission) light source which can be directly modulated. The ASE light source is a light source that emits high-intensity, wideband incoherent light. By having the ASE light source, the optical transmitter 20 can perform wideband optical transmission.

When the transmission data 82 is input, for example, the incoherent light source 205 which can be directly modulated adds a modulation signal based on the transmission data 82 to the drive current of a laser diode, thereby modulating light intensity of the laser diode, and transmits the resultant light as the incoherent light 90a. The operations of the optical transmission system 104 after the incoherent light 90a transmitted from the optical transmitter 20 until the incoherent light 90a is received by the optical receiver 15 are similar to those in the first embodiment.

As described above, the fourth embodiment is obtained by embodying the configuration of the optical transmitter 20 in the second embodiment in a manner similar to the third embodiment. For reasons similar to those of the second embodiment, degradation in the received waveform due to mechanical disturbance does not occur.

The configuration of the optical transmitter 20 having the incoherent light source 205 which can be directly modulated as shown in FIG. 7 can be applied to any of the embodiments described in the specification.

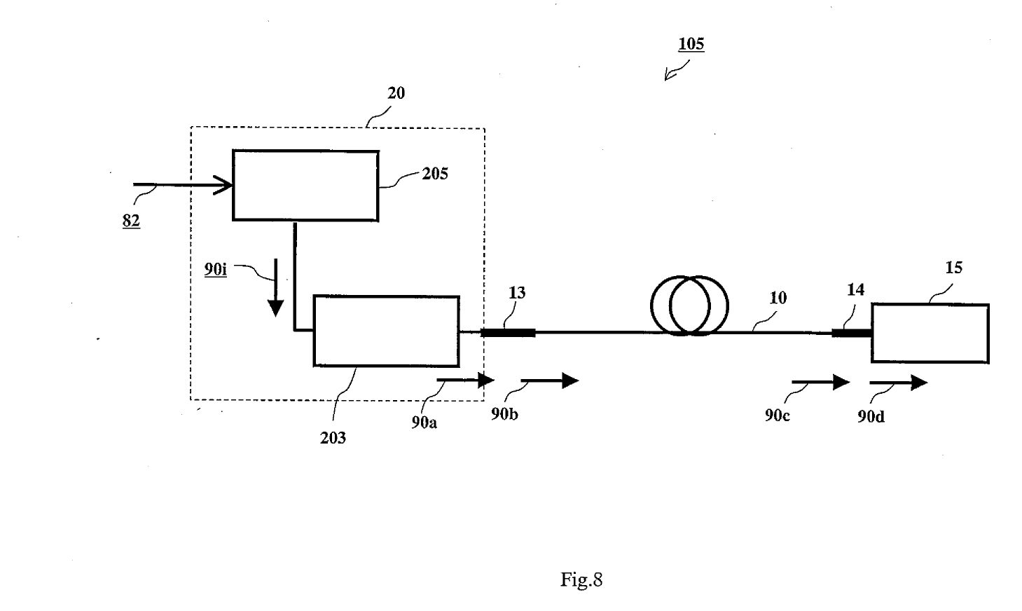

FIG. 8 shows another example of the fourth embodiment of the optical transmission system according to the invention. 203 denotes a wavelength filter mechanism as shown in FIG. 6. 205 denotes an incoherent light source which can be directly modulated as shown in FIG. 7.

In the configuration example, the wavelength filter mechanism 203 is inserted to suppress waveform degradation caused by wavelength dispersion of the graded-index multimode optical fiber 10. Since the optical transmitter 20 has the incoherent light source 205 which can be directly modulated, the optical transmitter 20 can be made compact.

The operation of the optical transmitter 20 of the optical transmission system 105 according to the fifth embodiment will be described. The operations of the optical transmission system 105 after the incoherent light 90a is transmitted from the optical transmitter 20 until the incoherent light is received by the optical receiver 15 are similar to those in the first embodiment.

First, when the transmission data 82 is input, for example, the incoherent light source 205 which can be directly modulated adds a modulation signal based on the transmission data 82 to the drive current of a laser diode, thereby modulating light intensity of the laser diode, and transmits the resultant light as incoherent light 90i. The incoherent light 90i is received by the wavelength filter mechanism 203. The wavelength filter mechanism 203 limits the wavelength range of the incoherent light 90i and transmits the resultant light as the incoherent light 90a.

As described above, the fourth embodiment is obtained by embodying the configuration of the optical transmitter 20 in, the second embodiment. For reasons similar to those of the second embodiment, degradation in the received waveform due to mechanical disturbance does not occur.

### Fifth Embodiment

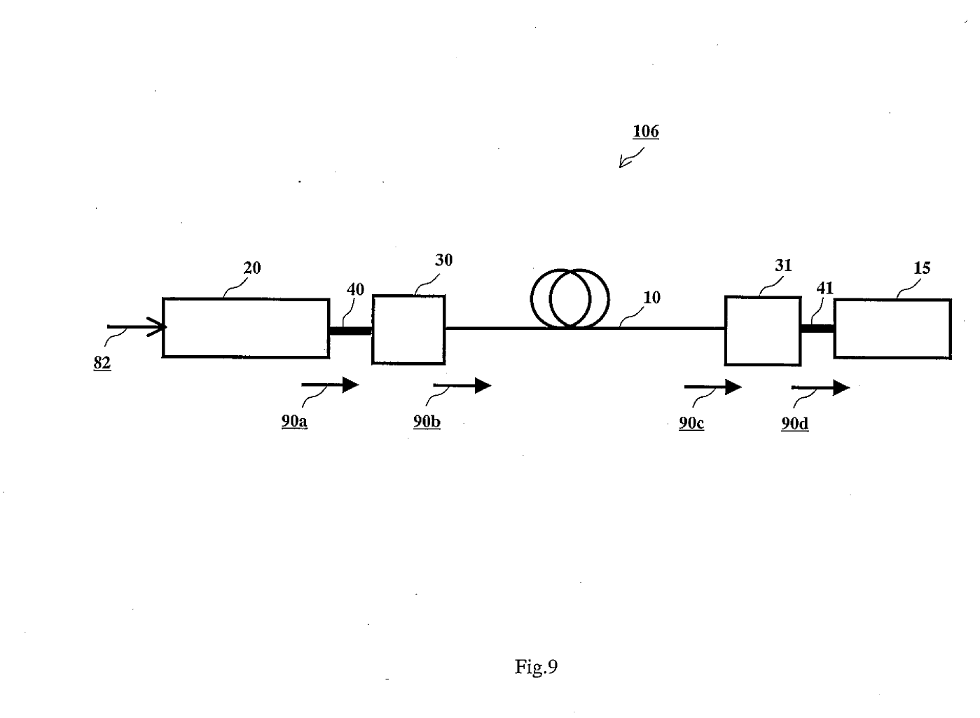

FIG. 9 shows a fifth embodiment of the optical transmission system according to the present invention. The same reference numerals are designated to the same components as those in FIG. 2. The configuration of the optical transmitter 20 is similar to that in the first embodiment.

In the fifth embodiment, a single-mode planar lightwave circuit 30 for excitation is provided in place of the single-mode optical filter 13 as an excitation mechanism shown in FIG. 2. A single-mode planar lightwave circuit 31 for transmission is provided in place of the single-mode optical fiber 14 for transmission as a transmission mechanism. Further, a graded-index multimode optical fiber 40 for connecting the optical transmitter 20 and the single-mode planar lightwave circuit 30 for excitation as an excitation mechanism, and a graded-index multimode optical fiber 41 for connecting the single-mode planar lightwave circuit 31 for transmission as a transmission mechanism and the optical receiver 15 are provided.

The single-mode planar lightwave circuit 30 for excitation and the single-mode planar lightwave circuit 31 for transmission can be made by using a quartz material or semiconductor crystal. In the fifth embodiment, by applying the single-mode planar lightwave circuit 30 for excitation as an excitation mechanism and the single-mode planar lightwave circuit 31 for transmission as a transmission mechanism, miniaturization of the excitation mechanism and the transmission mechanism can be realized.

In the fifth embodiment, on the transmitter side, when a light signal is supplied to the graded-index multimode optical fiber 10, only the base mode is excited by the single-mode planar lightwave circuit 30 for excitation. On the receiver side, a component which has been transferred to a high-order mode during transmission is eliminated by the single-mode planar lightwave circuit 31 for transmission and only the base mode is selectively led to the optical receiver 15.

The operation of the optical transmission system 106 of the fifth embodiment will be described.

First, the optical transmitter 20 transmits the incoherent light 90a, which is an optical signal converted from transmission data 82 input to the optical transmitter 20, toward the optical receiver 15. The incoherent light 90a transmitted from the optical transmitter 20 propagates through the graded-index multimode optical fiber 40 for connection, passes through the single-mode planar lightwave circuit 30 for excitation and enters, as the incoherent light 90b, the graded-index multimode optical fiber 10. Since the incoherent light 90a propagates through the graded-index multimode optical fiber 40 for connection, variations in propagation delay caused by mode dispersion can be suppressed more than the case of using a step-index multimode optical fiber. Since the incoherent light 90a is limited to the base mode when it passes through the single-mode planar lightwave circuit 30, mode dispersion of the incoherent light 90b propagating through the graded-index multimode optical fiber 10 can be suppressed.

The incoherent light 90c propagated through the graded-index multimode optical fiber 10 passes through the single-mode planar lightwave circuit 31 for transmission and propagates through the graded-index multimode optical fiber 40 41 for connection. After that, the incoherent light 90c is transmitted as the incoherent light 90d toward the optical receiver 15. Since the incoherent light 90c is limited to the base mode when it passes through the single-mode planar lightwave circuit 31 for transmission and is transmitted toward the optical receiver 15, mode dispersion in the incoherent light 90d can be suppressed. Therefore, degradation of the received waveform in the optical receiver 15 can be prevented. Since the incoherent light 90c propagates through the graded-index multimode optical fiber 41 for connection, variations in propagation delay caused by the mode dispersion can be suppressed more than the case of using a step index multimode optical fiber. Further, the incoherent light is used as light transmitted/received between the optical transmitter 20 and the optical receiver 15, so that interference itself among the modes can be suppressed. Therefore, degradation in received waveform in the optical receiver 15 can be prevented.

As described above, also in the fifth embodiment, degradation in the received waveform due to mechanical disturbance does not occur for reasons similar to those of the second embodiment.

In the fifth embodiment, the graded-index multimode optical fiber 40 for connection is used to connect the optical transmitter 20 and the single-mode planar lightwave circuit 30 for excitation and the graded-index multimode optical fiber 41 for connection is used to connect the single-mode planar lightwave circuit 31 for transmission and the optical receiver 15. In place of the graded-index multimode optical fibers 40 and 41 for connection, single-mode optical fibers may be used for connection.

It is also possible to directly couple the optical transmitter 20 and the single-mode planar lightwave circuit 30 for excitation and directly couple the single-mode planar lightwave circuit 31 for transmission and the optical receiver 15. Various configurations are possible.

### Sixth Embodiment

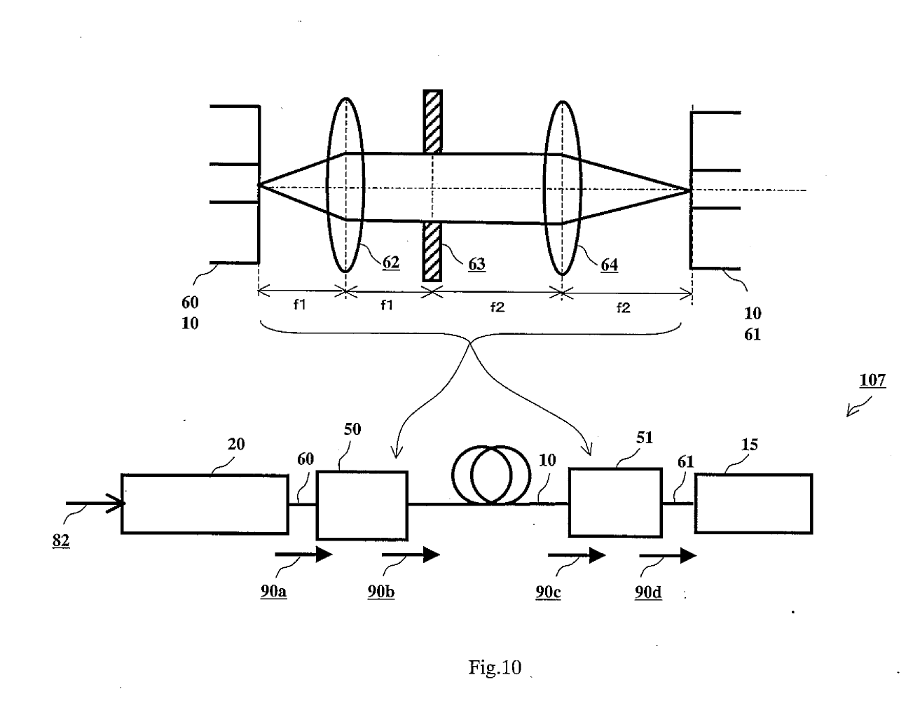

FIG. 10 shows a sixth embodiment of the optical transmission system according to the present invention. The same reference numerals are designated to the same components as those in FIG. 2. The configuration of the optical transmitter 20 is similar to that in the first embodiment.

In the sixth embodiment, an optical system 50 for excitation is provided in place of the single-mode optical filter 13 as an excitation mechanism shown in FIG. 2. An optical system 51 for transmission is provided in place of the single-mode optical fiber 14 for transmission as a transmission mechanism. Further, a graded-index multimode optical fiber 60 for connecting the optical transmitter 20 and the optical system 50 for excitation and a graded-index multimode optical fiber 61 for connecting the optical system 51 for transmission and the optical receiver 15 are provided.

In the sixth embodiment, the optical system 50 for excitation as an excitation mechanism includes a lens that transmits the incoherent light 90a transmitted from the optical transmitter 20. A predetermined low-order mode in the incoherent light 90a transmitted from the optical transmitter 20 is condensed by the lens and transmitted. The optical system 51 for transmission as a transmission mechanism includes a lens that transmits the incoherent light 90c transmitted from the optical system 50 for excitation as an excitation mechanism. A predetermined low-order mode in the incoherent light 90c transmitted from the optical system 50 for excitation as an excitation mechanism is condensed by the lens and transmitted. In the sixth embodiment, as a mechanism for exciting a specific mode, the optical system 50 for excitation including two lenses and a diaphragm capable of selectively condensing only low-order mode components having small angles of incidence is used at the connection point between the graded-index multimode optical fiber 60 for connection connected to the optical transmitter 20 and the graded-index multimode optical fiber 10. As a mechanism capable of transmitting the specific mode, the optical system 51 for transmission including two lenses and a diaphragm capable of selectively condensing only low-order mode components having small angles of incidence is used at the connection point between the graded-index multimode optical fiber 61 for connection connected to the optical receiver 15 and the graded-index multimode optical fiber 10.

The operation of the optical system 50 for excitation as an excitation mechanism will now be described. The principle of operation of the optical system 51 for transmission as a transmission mechanism is similar to that of the optical system 50 for excitation.

The incoherent light 90a transmitted from the optical transmitter 20 propagates through the graded-index multimode optical fiber 60 and enters a first lens 62 in the optical system 50 for excitation. The distance between the graded-index multimode optical fiber 60 and the first lens 62 is made coincide with a focal length f1 of the first lens 62. Consequently, the first lens 62 makes the incident incoherent light deflects so that light rays become parallel so that the parallel rays enter the diaphragm 63.

Only the parallel rays which are incident on the diaphragm 63 and pass through the aperture in the diaphragm 63 are incident on a second lens 64. By adjusting the aperture in the diaphragm 63, the mode of light passing through the aperture in the diaphragm 63 can be made a low-order mode. Consequently, by making the incoherent light 90a pass through the diaphragm 63, mainly, low-order modes in the incoherent light 90a can be excited.

The rays passed through the diaphragm 63 and incident on the second lens 64 are condensed by the second lens 64 and the condensed light enters the graded-index multimode optical fiber 10. The distance between the second lens 64 and the graded-index multimode optical fiber 10 is made coincide with a focal length f2 of the second lens 64 so that the rays of the incoherent light incident on the second lens 64 are condensed to the graded-index multimode optical fiber 10.

Although the optical system 50 includes two lenses and one diaphragm in the fifth embodiment, by applying, as the first lens 62, a lens having a small diameter which can transmit mainly low-order modes in the incoherent light 90a, the diaphragm 63 may be omitted. In this case, the number of parts is smaller, so that optical system 50 for excitation can be made compact.

By using the optical systems 50 and 51, specified low-order mode components whose angles of incidence with respect to the center axis in the graded-index multimode fiber 10 are small and whose power is concentrated in and around the core center can be excited, and the resultant light can be passed.

Therefore, on the transmitter side, only the specific low-order modes are excited in the graded-index multimode optical system 10 connected to the optical system 50 for excitation. On the receiver side, by using a similar optical system, component transited to high-order modes during transmission are eliminated, and only the specific low-order modes can be selectively received.

Also in the sixth embodiment, degradation in the received waveform due to mechanical disturbance does not occur for reasons similar to those of the second embodiment.

In the sixth embodiment, the graded-index multimode optical fiber 60 for connection is used to connect the optical transmitter 20 and the optical system 50 for excitation, and the graded-index multimode optical fiber 61 for connection is used to connect the optical system 51 for transmission and the optical receiver 15. In place of the graded-index multimode optical fiber 60 and 61 for connection, single-mode optical fibers may be used for connection.

The optical transmitter 20 and the optical receiver 15 may be directly coupled to each other. Various configurations are possible.

### Seventh Embodiment

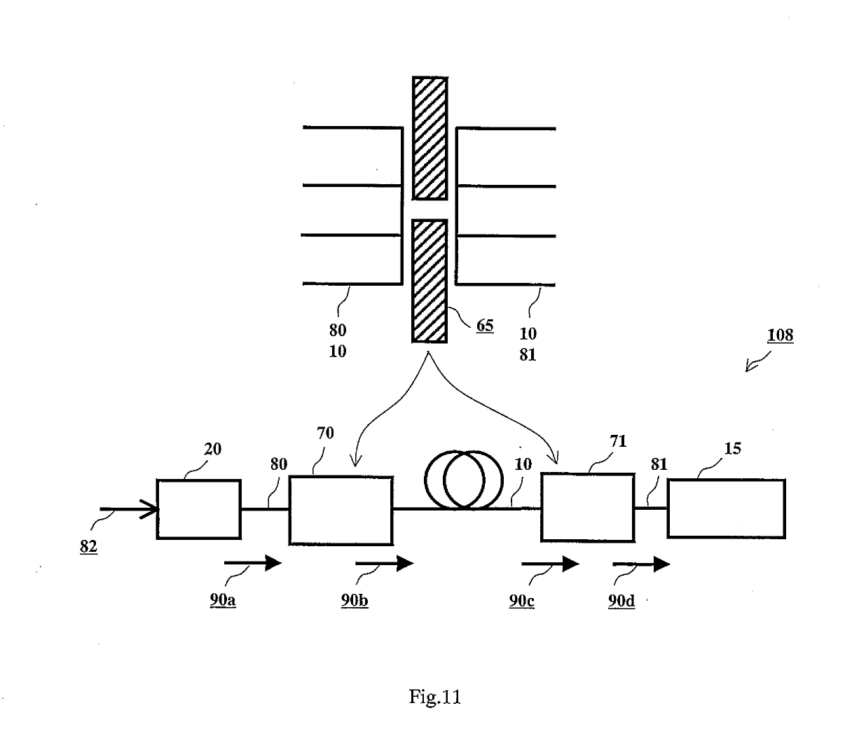

FIG. 11 shows a seventh embodiment of the optical transmission system according to the present invention. The same reference numerals are designated to the same components as those in FIG. 2. The configuration of the optical transmitter 20 is similar to that in the first embodiment.

In the seventh embodiment, a diaphragm 70 for excitation is provided in place of the single-mode optical filter 13 as an excitation mechanism shown in FIG. 2. A diaphragm 71 for transmission is provided in place of the single-mode optical fiber 14 for transmission as a transmission mechanism. Further, a graded-index multimode optical fiber 80 for connecting the optical transmitter 20 and the diaphragm 70 for excitation and a graded-index multimode optical fiber 81 for connecting the diaphragm 71 for transmission and the optical receiver 15 are provided.

In the seventh embodiment, the diaphragm 70 for excitation as an excitation mechanism includes a diaphragm having an aperture that transmits the incoherent light 90a transmitted from the optical transmitter 20. A predetermined low-order mode in the incoherent light 90a transmitted from the optical transmitter 20 is selected by the diaphragm and transmitted. The diaphragm 71 for transmission as a transmission mechanism includes an aperture that transmits the incoherent light 90c transmitted from the diaphragm 70 for excitation as an excitation mechanism. A predetermined low-order mode in the incoherent light 90c transmitted from the diaphragm 70 for excitation as an excitation mechanism is selected by the diaphragm and transmitted. In the seventh embodiment, as a mechanism for exciting a specific mode, the diaphragm 70 for excitation is used at the connection point between the graded-index multimode optical fiber 80 for connection connected to the optical transmitter 20 and the graded-index multimode optical fiber 10. As a mechanism capable of transmitting the specific mode, the diaphragm 71 for transmission is used at the connection point between the graded-index multimode optical fiber 81 for connection connected to the optical receiver 15 and the graded-index multimode optical fiber 10.

By using the diaphragms 70 and 71, specified low-order mode components whose angles of incidence with respect to the center axis in the graded-index multimode fiber 10 are small and whose power is concentrated in and around the core center can be excited, and the resultant light can be transmitted.

The operation of the diaphragm 70 for excitation as an excitation mechanism will now be described. The principle of operation of the diaphragm 71 for transmission as a transmission mechanism is similar to that of the diaphragm 70 for excitation.

The incoherent light 90a transmitted from the optical transmitter 20 propagates through the graded-index multimode optical fiber 80 and enters a diaphragm 65 in the diaphragm 70 for excitation. The light incident on the diaphragm 65 passes through the diaphragm 65 only by the amount corresponding to the aperture in the diaphragm 65, and enters the graded-index multimode optical fiber 10. Consequently, by adjusting the size of the aperture in the diaphragm 65, the mode of the coherent light 90a passing through the aperture in the diaphragm 65 can be made a low-order mode.

Although the diaphragm 70 for excitation includes one diaphragm in the embodiment, it may include two diaphragms.

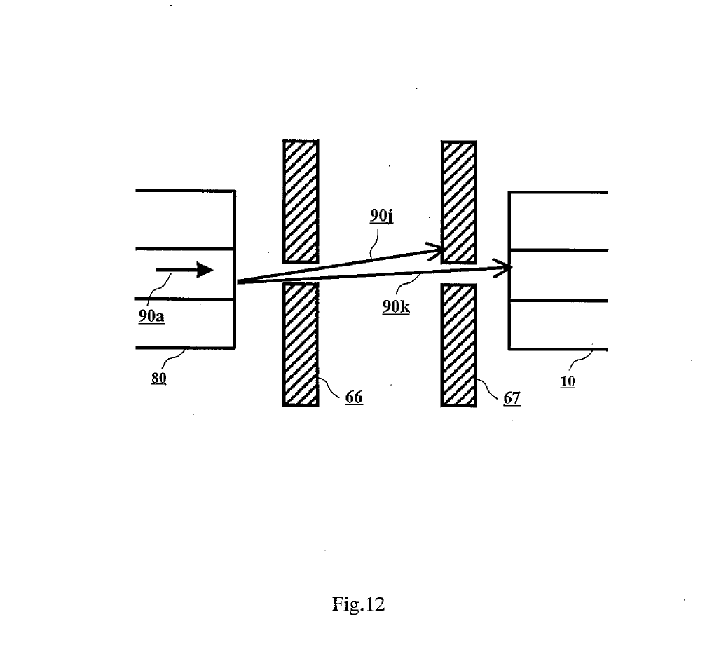

FIG. 12 is a schematic configuration diagram showing another example of the configuration of the diaphragm 70 for excitation.

The diaphragm for excitation shown in FIG. 12 includes a first diaphragm 66 transmitting the incoherent light 90a transmitted from the optical transmitter 20 and a second diaphragm 67 transmitting incoherent light 90k passed through the first diaphragm 66.

When the configuration of the diaphragm 70 for excitation shown in FIG. 11 is replaced by the configuration of FIG. 12, incoherent light 90j in a high-order mode emitted from not the center but the peripheral part of the graded-index multimode optical fiber 80 and passed through the first diaphragm 66 can be blocked by the second diaphragm 67. Even when incoherent light emitted from not the center but the peripheral part of the graded-index multimode optical fiber 80 is used, mainly low-order modes pass through the second diaphragm 67. Consequently, the rejection ratio of high-order modes in the incoherent light 90a can be increased.

To the diaphragm 71 for transmission shown in FIG. 11, the configuration shown in FIG. 12 can be applied.

As described above, also in the seventh embodiment, for reasons similar to those of the second embodiment, degradation in the received waveform due to mechanical disturbance does not occur.

In the seventh embodiment, it is not always easy to extract pure specific mode components. However, the relative intensity of remaining components other than the specific mode can be suppressed to a portion as much as it does not disturb practical use.

Although the case of singly using the diaphragm 70 for excitation and the diaphragm 71 for transmission has been described in the embodiment, there are various possible configurations such as a configuration in which a diaphragm is incorporated in a connection point of a connector for connecting an optical fiber.

1. An optical transmission system having:
an optical transmitter for transmitting incoherent light;
an excitation mechanism for exciting a predetermined mode in the incoherent light transmitted from the optical transmitter or the incoherent light transmitted from the optical transmitter via a multimode optical transmission line; and
a transmission mechanism for transmitting a predetermined mode in the incoherent light transmitted from the excitation mechanism via a multimode optical transmission line.

2. An optical transmission system having:
an optical transmitter for transmitting incoherent light;
an excitation mechanism for exciting a predetermined mode in the incoherent light transmitted from the optical transmitter or the incoherent light transmitted from the optical transmitter via a multimode optical transmission line;
a transmission mechanism for transmitting a predetermined mode in the incoherent light transmitted from the excitation mechanism via a multimode optical transmission line; and
an optical receiver for receiving the incoherent light transmitted from the transmission mechanism or the incoherent light transmitted from the transmission mechanism via a multimode optical transmission line.

3. An optical transmission system having:
an optical transmitter for transmitting incoherent light;
an excitation mechanism for exciting a predetermined mode in the incoherent light transmitted from the optical transmitter or the incoherent light transmitted from the optical transmitter via a multimode optical transmission line;
a multimode optical transmission line for transmitting the incoherent light transmitted from the excitation mechanism; and
a transmission mechanism for transmitting a predetermined mode in the incoherent light transmitted from the excitation mechanism via the multimode optical transmission line.

4. An optical transmission system having:
an optical transmitter for transmitting incoherent light;
an excitation mechanism for exciting a predetermined mode in the incoherent light transmitted from the optical transmitter or the incoherent light transmitted from the optical transmitter via a multimode optical transmission line;
a multimode optical transmission line for transmitting the incoherent light transmitted from the excitation mechanism;
a transmission mechanism for transmitting a predetermined mode in the incoherent light transmitted from the excitation mechanism via the multimode optical transmission line; and
an optical receiver for receiving the incoherent light transmitted from the transmission mechanism or the incoherent light transmitted from the transmission mechanism via a multimode optical transmission line.

5. The optical transmission system according to claim 1 or 3, wherein the optical transmitter has an incoherent light source and a optical modulator for modulating light emitted from the incoherent light source and outputting the modulated light as the incoherent light.

6. The optical transmission system according to claim 1 or 3, wherein the optical transmitter has an incoherent light source which can be directly modulated and emits the incoherent light.

7. The optical transmission system according to claim 5, wherein the incoherent light source is an ASE light source.

8. The optical transmission system according to claim 6, wherein the incoherent light source is an ASE light source.

9. The optical transmission system according to claim 3, wherein a graded-index optical transmission line is used as the multimode optical transmission line.

10. The optical transmission system according to claim 9, wherein the graded-index optical transmission line takes the form of a graded-index multimode optical fiber having a core diameter of 40 μm or more and 100 μm or less.

11. The optical transmission system according to claim 9, wherein the graded-index optical transmission line takes the form of a graded-index multimode optical fiber having a core diameter of 50 μm or 62.5 μm.

12. The optical transmission system according to claim 3, wherein a step index optical transmission line is used as the multimode optical transmission line.

13. The optical transmission system according to claim 12, wherein the step index optical transmission line takes the form of a step index multimode optical fiber having a core diameter of 40 μm or more and 100 μm or less.

14. The optical transmission system according to claim 12, wherein the step index optical transmission line takes the form of a step index multimode optical fiber having a core diameter of 50 μm or 62.5 μm.

15. The optical transmission system according to claim 1 or 3, wherein the predetermined mode is a base mode.

16. The optical transmission system according to claim 1 or 3, wherein a single-mode optical transmission line is used as the excitation mechanism.

17. The optical transmission system according to claim 16, wherein a single-mode optical fiber is used as the single-mode optical transmission line.

18. The optical transmission system according to claim 16, wherein a single-mode planar lightwave circuit is used as the single-mode optical transmission line.

19. The optical transmission system according to claim 1 or 3, wherein the excitation mechanism includes a lens that transmits the incoherent light transmitted from the optical transmitter, a predetermined low-order mode in the incoherent light transmitted from the optical transmitter is condensed by the lens, and the resultant light is transmitted.

20. The optical transmission system according to claim 1 or 3, wherein the excitation mechanism includes a diaphragm having an aperture that passes the incoherent light transmitted from the optical transmitter, a predetermined low-order mode in the incoherent light transmitted from the optical transmitter is selected by the diaphragm, and the resultant light is transmitted.

21. The optical transmission system according to claim 20, wherein the diaphragm includes a first diaphragm for passing the incoherent light transmitted from the optical transmitter and a second diaphragm for passing the incoherent light passed through the first diaphragm.

22. The optical transmission system according to claim 1 or 3, wherein a single-mode optical transmission line is used as the transmission mechanism.

23. The optical transmission system according to claim 22, wherein a single-mode optical fiber is used as the single-mode optical transmission line.

24. The optical transmission system according to claim 22, wherein a single-mode planar lightwave circuit is used as the single-mode optical transmission line.

25. The optical transmission system according to claim 1 or 3, wherein the transmission mechanism includes a lens that transmits the incoherent light transmitted from the excitation mechanism, a predetermined low-order mode in the incoherent light transmitted from the excitation mechanism is condensed by the lens, and the resultant light is transmitted.

26. The optical transmission system according to claim 1 or 3, wherein the transmission mechanism includes a diaphragm having an aperture that passes the incoherent light transmitted from the excitation mechanism, a predetermined low-order mode in the incoherent light transmitted from the excitation mechanism is selected by the diaphragm, and the resultant light is transmitted.

27. The optical transmission system according to claim 26, wherein the diaphragm includes a first diaphragm for passing the incoherent light transmitted from the excitation mechanism and a second diaphragm for passing the incoherent light passed through the first diaphragm.
